(19) United States
(12) Patent Application Publication
(10) Pub. No.: US 2014/0289400 A1
(43) Pub. Date: Sep. 25, 2014

(54) MONITORING SYSTEM, MONITORING APPARATUS, MONITORING-TARGET APPARATUS, MONITORING METHOD AND COMPUTER-READABLE RECORDING MEDIUM HAVING STORED THEREIN MONITORING PROGRAM

(71) Applicants: CASIO COMPUTER CO., LTD., Tokyo (JP); CASIO ELECTRONICS MANUFACTURING CO., LTD., Iruma-shi (JP)

(72) Inventor: Hiroshi SAITO, Tokyo (JP)

(73) Assignees: CASIO COMPUTER CO., LTD., Tokyo (JP); CASIO ELECTRONICS MANUFACTURING CO., LTD., Iruma-shi (JP)

(21) Appl. No.: 14/222,491

(22) Filed: Mar. 21, 2014

(30) Foreign Application Priority Data
Mar. 22, 2013 (JP) 2013-060845

(51) Int. Cl. H04L 12/26

(52) U.S. Cl. CPC H04L 43/0805
USPC 709/224

(57) ABSTRACT

A monitoring system includes a monitoring apparatus and a monitoring-target apparatus connected therewith via a network. The monitoring apparatus includes an inquirer that inquires as to whether or not the monitoring-target apparatus is capable of obtaining a status thereof. The monitoring-target apparatus includes a responder that transmits, when the monitoring-target apparatus is in a first status in which the status is obtainable, a response to the inquiry. The monitoring apparatus further includes a receiver that receives the response to the inquiry, and a requester that requests, when the receiver receives the response, the monitoring-target apparatus transmitted the received response to obtain the status of the monitoring-target apparatus. The monitoring-target apparatus further includes a communication controller that does not respond to the inquiry and the monitoring-target apparatus is in a second status in which the status is not obtainable, and that maintains the local monitoring-target apparatus in the second status.

### CROSS-REFERENCE TO RELATED APPLICATION

This application claims the benefit of Japanese Patent Application No. 2013-060845, filed on Mar. 22, 2013, the entire disclosure of which is incorporated by reference herein.

### FIELD

This application relates generally to a monitoring system, a monitoring apparatus, a monitoring-target apparatus, a monitoring method, and a computer-readable recording medium having stored therein a monitoring program.

### BACKGROUND

Conventionally, a technology so-called WOL (Wake On LAN) is known which returns, to a normal mode, a device like a printer operated in a mode (power saving mode) in which power consumption is reduced through an activation instruction transmitted through a network.

In such a technology, a device in a power saving mode can be also activated by an ARP (Address Resolution Protocol) request and the like issued to obtain, for example, address information. Hence, when, for example, a monitoring based on SNMP (Simple Network Management Protocol) is periodically performed on a device in a power saving mode, an ARP request is issued prior to a status obtainment packet issued for the purpose of the monitoring, and this ARP request frequently interrupts the power saving mode.

Conversely, for example, Unexamined Japanese Patent Application Kokai Publication No. 2012-53842 discloses a technology of suppressing an interruption of the power saving mode of a printer device when the status of the printer device corresponding to the WOL over a network is obtained through the SNMP. According to the technology disclosed in such a Publication, a monitoring apparatus registers address information in a fixed manner including an IP (Internet Protocol) address and a MAC (Media Access Control) address of the printer device, and obtains the status of the printer device using the address information registered in a fixed manner. Hence, it is unnecessary to issue an ARP request prior to an obtainment of the status, and it becomes possible to suppress an interruption of the power saving mode of the printer device that is caused every time the status is obtained.

According to the technology of registering the address information of a monitoring target in a fixed manner, however, when, for example, the address information is changed, it is sometimes difficult to flexibly cope with such a change. Hence, there is a demand for a different technology that prevents a monitoring apparatus from obtaining a status when a monitoring-target apparatus is in a mode that is inadequate for monitoring like a power saving mode.

### SUMMARY

A monitoring system according to an aspect of the present invention includes: a monitoring apparatus; and a monitoring-target apparatus connected with the monitoring apparatus via a network, in which the monitoring apparatus includes an inquirer that inquires whether or not the monitoring-target apparatus is capable of obtaining a status thereof; the monitoring-target apparatus includes a responder that transmits, when the monitoring-target apparatus is in a first status in which the status is obtainable, a response to the inquiry when the monitoring-target apparatus receives the inquiry; the monitoring apparatus further includes: a receiver that receives the response to the inquiry transmitted from the monitoring-target apparatus; and a requester that requests the monitoring-target apparatus having transmitted the received response to obtain a statement of the monitoring-target apparatus when the receiver receives the response; and the monitoring-target apparatus further includes a communication controller that does not respond to the inquiry when the monitoring-target apparatus receives the inquiry and the monitoring-target apparatus is in a second status in which the status is not obtainable, and that maintains the monitoring-target apparatus in the second status.

A monitoring apparatus according to a second aspect of the present invention is an external apparatus monitoring a monitoring-target apparatus including a responder and a communication controller, in which: the responder transmits, when the monitoring-target apparatus is in a first status in which a status thereof is obtainable and the monitoring-target apparatus receives a predetermined inquiry, a response to the inquiry to the external apparatus; the communication controller does not respond to the inquiry when the monitoring-target apparatus receives the inquiry and the monitoring-target apparatus is in a second status in which the status is not obtainable, and that maintains the local monitoring-target apparatus in the second status; the monitoring apparatus includes: an inquirer that performs the inquiry as to whether or not the monitoring-target apparatus is obtainable the status thereof; a receiver that receives the response to the inquiry transmitted from the monitoring-target apparatus when the monitoring-target apparatus is in the first status; and a requester that requests, when the receiver receives the response, the monitoring-target apparatus having transmitted the received request to obtain the status of the monitoring-target apparatus.

A monitoring-target apparatus according to a third aspect of the present invention is connected with a monitoring apparatus via a network, the monitoring apparatus including: an inquirer that performs an inquiry as to whether or not the monitoring-target apparatus is obtainable a status thereof; a receiver that receives a response to the inquiry transmitted from the monitoring-target apparatus when the monitoring-target apparatus is in a first status in which the status is obtainable; and a requester that requests, when the receiver receives the response, the monitoring-target apparatus having transmitted the received request to obtain the status of the monitoring-target apparatus, the monitoring-target apparatus including: a responder that transmits, when the monitoring-target apparatus receives the inquiry and the monitoring-target apparatus is in a status in which the status is obtainable, the response to the inquiry; and a communication controller that does not respond to the inquiry when the monitoring-target apparatus receives the inquiry from the monitoring apparatus and the monitoring-target apparatus is in a second status in which the status is not obtainable, and that maintains the local monitoring-target apparatus in the second status.

A monitoring method according to a fourth aspect of the present invention is for monitoring a monitoring-target apparatus comprising a responder and a communication controller, in which: the responder transmits, when the monitoring-target apparatus is in a first status in which a status thereof is obtainable and the monitoring-target apparatus receives a predetermined inquiry, a response to the inquiry to a monitoring apparatus connected with the monitoring-target apparatus via a network; and the communication controller does not respond to the inquiry when the monitoring-target apparatus receives the inquiry and the monitoring-target apparatus is in a second status in which the status is not obtainable, and that maintains the local monitoring-target apparatus in the second status; the monitoring method includes: an inquiring step for performing the inquiry as to whether or not the status of the monitoring-target apparatus is obtainable; a receiving step for receiving the response to the inquiry transmitted from the monitoring-target apparatus when the monitoring-target apparatus is in the first status; and a requesting step for requesting, when the response is received through the receiving step, the monitoring-target apparatus having transmitted the received request to obtain the status of the monitoring-target apparatus.

A computer-readable non-transitory recording medium according to a fifth aspect of the present invention has stored therein a monitoring program that causes a computer to execute a monitoring method for monitoring a monitoring-target apparatus including a responder and a communication controller, in which: the responder transmits, when the monitoring-target apparatus is in a first status in which a status thereof is obtainable and the monitoring-target apparatus receives a predetermined inquiry, a response to the inquiry to a monitoring apparatus connected with the monitoring-target apparatus via a network; and the communication controller does not respond to the inquiry when the monitoring-target apparatus receives the inquiry and the monitoring-target apparatus is in a second status in which the status is not obtainable, and that maintains the local monitoring-target apparatus in the second status; the monitoring program causes the computer to execute: performing the inquiry as to whether or not the status of the monitoring-target apparatus is obtainable;

receiving the response to the inquiry transmitted from the monitoring-target apparatus when the monitoring-target apparatus is in the first status; and requesting, when the response is received, the monitoring-target apparatus having transmitted the received request to obtain the status of the monitoring-target apparatus.

### BRIEF DESCRIPTION OF THE DRAWINGS

A more complete understanding of this application can be obtained when the following detailed description is considered in conjunction with the following drawings, in which:

FIG. 1 is a diagram schematically illustrating a monitoring system according to an embodiment of the present invention;

FIG. 2 is a block diagram illustrating a structure of a host computer illustrated in FIG. 1;

FIG. 3 is a block diagram illustrating a structure of a printer illustrated in FIG. 1;

FIG. 4 is a diagram illustrating a structure of printer status information stored in the host computer illustrated in FIG. 2;

FIG. 5 is a diagram illustrating a structure of status information stored in the printer illustrated in FIG. 3;

FIG. 6 is a diagram illustrating structure of an activation packet information stored in the printer illustrated in FIG. 3;

FIG. 7 is a flowchart illustrating a monitoring process executed by the host computer, and a packet receiving process executed by the printer according to the embodiment of the present invention; and

FIG. 8 is a flowchart illustrating a process when the printer is in a power saving mode.

### DETAILED DESCRIPTION

An explanation will be given of an embodiment of the present invention with reference to the accompanying drawings. The same or corresponding element throughout the drawings will be denoted by the same reference numeral.

An embodiment explained below is for the purpose of explanation, and is not intended to limit the scope and spirit of the present invention. Hence, a person skilled in the art can carry out an embodiment in which each element to be discussed later is replaced with an equivalent, but such embodiment is also within the scope and spirit of the present invention. In addition, in order to facilitate understanding to the present invention, an explanation for a conventional technical matter not important to explain the present invention will be omitted accordingly in the following explanation.

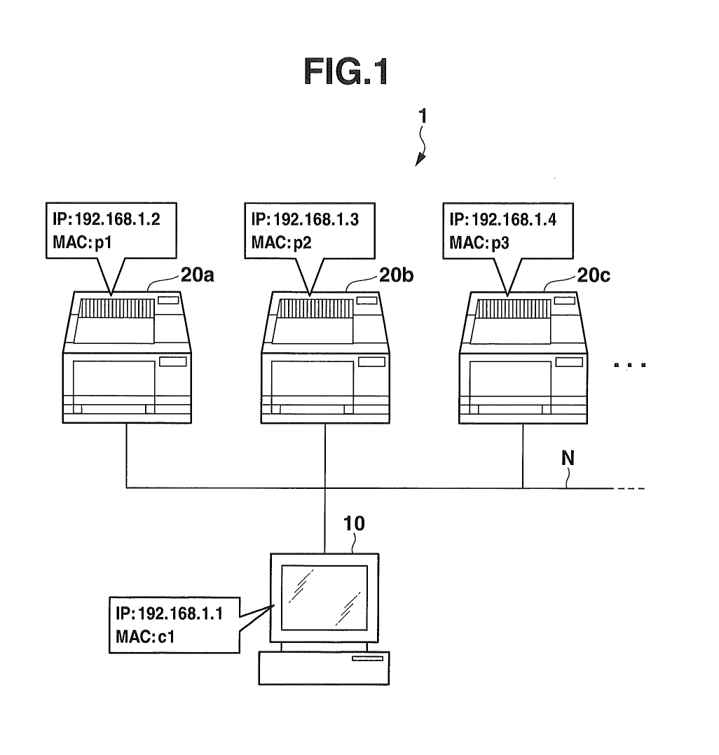

First of all, a structure of a monitoring system 1 according to an embodiment will be schematically explained with reference to FIG. 1. The monitoring system 1 includes a host computer 10, and printers 20a to 20c. The host computer 10 is connected with the printers 20a to 20c via a network N.

The host computer 10 is realized by a PC (Personal Computer). Conversely, the printers 20a to 20c are each realized by a printer device that executes a printing process in accordance with an operation given by a user or in response to an external request received through the network N. The printers 20a to 20c may be a device that performs this printing process only, or may be a multi-function apparatus further including a copying function, a scanner function, a facsimile function, and the like. In addition, the printers 20a to 20c have a sleep function that causes the printers to become a power saving mode (sleep mode) when a certain time elapses in a standby mode.

Still further, the printers 20a to 20c has a WOL function, and returns to a normal mode based on an activation packet transmitted through the network N when such printers are operated in the power saving mode. In this case, the power saving mode (first mode) is a condition in which power supply to the main controller of the printer 20 is terminated to suppress power consumption, but power is still supplied to a LAN I/F 23 to be discussed later. In such a power saving mode, the printer 20 is unable to perform a printing process, and to perform various response processes to various packets, but the LAN I/F 23 is still capable of processing the activation packet. In addition, a normal mode (second mode) is a condition in which power supply to the printer 20 and the LAN I/F 23 is maintained. In the normal mode, the printer 20 is capable of performing a printing process and response processes to various packets.

The network N is, for example, a LAN (Local Area Network) that is a combination of Ethernet (registered trademark) and TCP (Transmission Control Protocol)/IP (Internet Protocol). A connection to the network N can be a wired or wireless type. In addition, in the following explanation, when the respective printers 20a to 20c are not distinguished, such printers 20a to 20c will be simply explained as the printer 20. Still further, the monitoring system 1 includes one host computer 10, and three printers 20a to 20c, the number of those devices can be changed as needed.

A following explanation will be given of an example case in which the printer 20a and the printer 20b are subjected to monitoring by the host computer 10 among the three printers 20a to 20c. The host computer 20 stores respective pieces of unicast address information of the printer 20a and the printer 20b that are the monitoring targets.

The unicast address information includes a pair of an IP address and a MAC address. More specifically, “192.168.1.2” illustrated in FIG. 1 is the IP address in the unicast address information corresponding to the printer 20a, while “p1” is the MAC address in the unicast address information of the printer 20a.

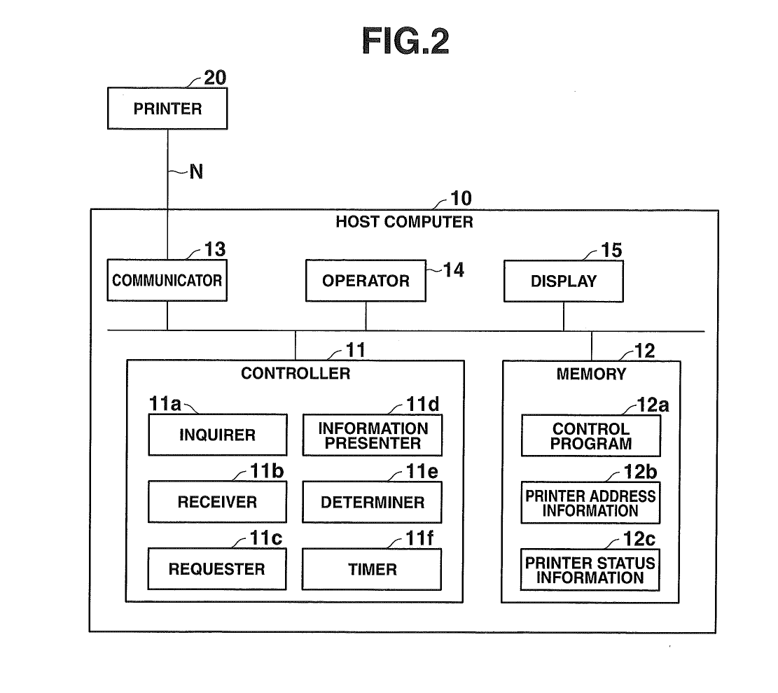

Next, with reference to FIG. 2, a structure of the host computer 10 illustrated in FIG. 1 will be explained. The host computer 10 includes a controller 11, a memory 12, a communicator 13, an operator 14, and a display 15.

The communicator 13 includes a communication interface like an NIC (Network Interface Card). The communicator 13 performs various communications with the printer 20 connected through the network N under the control of the controller 11.

The operator 14 includes input interfaces like a mouse and a keyboard. The operator 14 accepts various operations given by the user, and supplies signals corresponding to the accepted various operations to the controller 11. For example, the operator 14 supplies, to the controller 11, signals to set a printing condition in accordance with an operation given by the user, and signals to perform printing.

The display 15 includes a display device like a CRT (Cathode Ray Tube) or an LCD (Liquid Crystal Display). The display 15 displays various images on a screen based on various image data supplied from the controller 11. For example, the display 15 displays, under the control of the controller 11, the operating mode (normal mode, power saving mode) of the printer 20 that is the monitoring target, the remaining quantity of paper, the remaining quantity of toner, and the like.

The operator 14 and the display 15 may be commonly realized by a so-called touch panel. In this case, an input interface device and a display device included in the touch panel are superimposed with each other, and an operation signal corresponding to a position operated by the user in the touch panel is supplied to the controller 11.

The memory 12 includes memory devices like an HDD (Hard Disk Drive), a ROM (Read Only Memory), and a flash memory. The memory 12 stores various programs and data like an OS (Operating System) and various application programs run by the controller 11 to perform various processes, and various data generated or obtained upon execution of the various processes by the controller 11.

The memory 12 stores a control program 12a, monitoring printer address information 12b, and monitoring printer status information 12c.

The monitoring printer address information 12b includes unillustrated multicast address information and unicast address information. The multicast address information specifies a multicast address that enables the monitoring-target apparatus to respond. A packet (search packet to be discussed later) generated based on this multicast address information are received by all printers 20 including the printers 20 (printer 20a and printer 20b illustrated in FIG. 1) subjected to a monitoring.

Conversely, the unicast address information is address information to uniquely specify the printer 20 subjected to a monitoring. A packet (status request packet to be discussed later) generated based on this unicast address information are received by the printer 20 to which this address information is allocated (printer 20a or printer 20b illustrated in FIG. 1). In addition, the transmission originator of packets (response packet and status packet to be discussed later) received by the host computer 10 is uniquely specified based on the unicast address information.

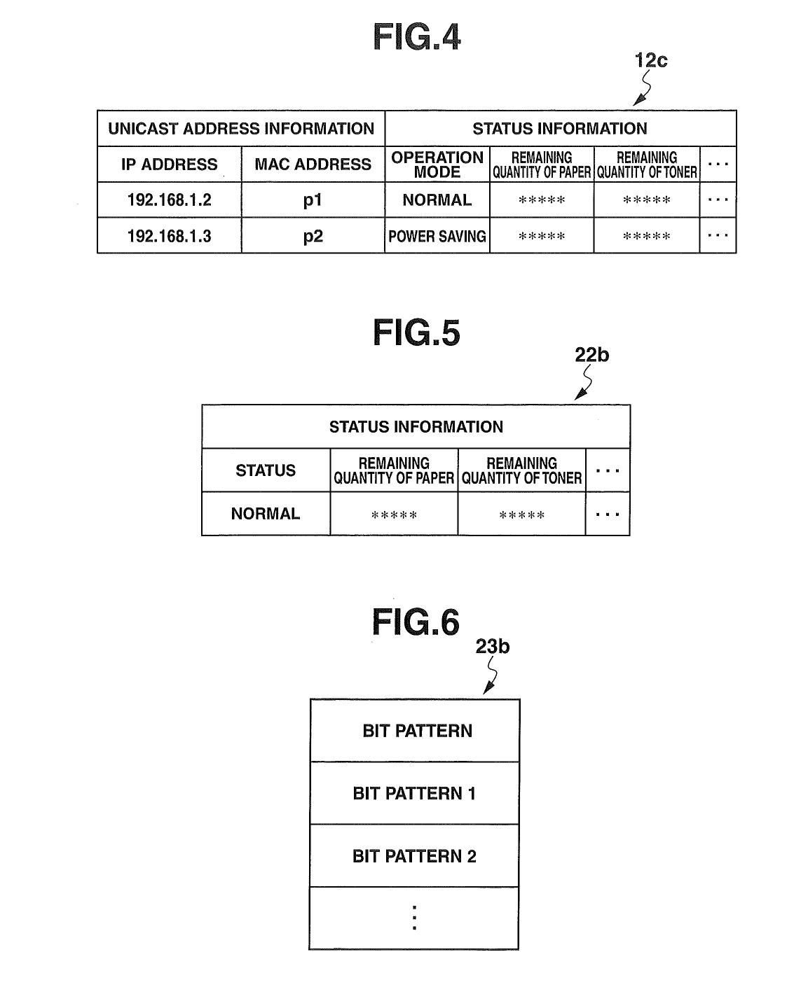

As illustrated in FIG. 4, the monitoring printer status information 12c includes the unicast address information and status information. The status information represents various statuses including, for example, the operating mode (normal mode, power saving mode, and the like) of the printer 20, the remaining quantity of paper, and remaining quantity of toner. In addition, the status information is updated based on a packet (status packet) received from the printer 20.

The controller 11 includes a CPU (Central Processing Unit), a RAM (Random Access Memory) serving as a main memory for the CPU, a timer, and the like. The controller 11 is connected with respective elements of the host computer 10 through a system bus that is a transmission channel to transfer an instruction and data, and controls the whole host computer 10. The controller 11 may partially include an exclusive circuit like an ASIC (Application Specific Integrated Circuit).

In addition, the controller 11 functions as an inquirer 11a, a receiver 11b, a requester 11c, an information presenter 11d, a determiner 11e, and a timer 11f. The respective elements 11a to 11f perform various processes to be discussed later.

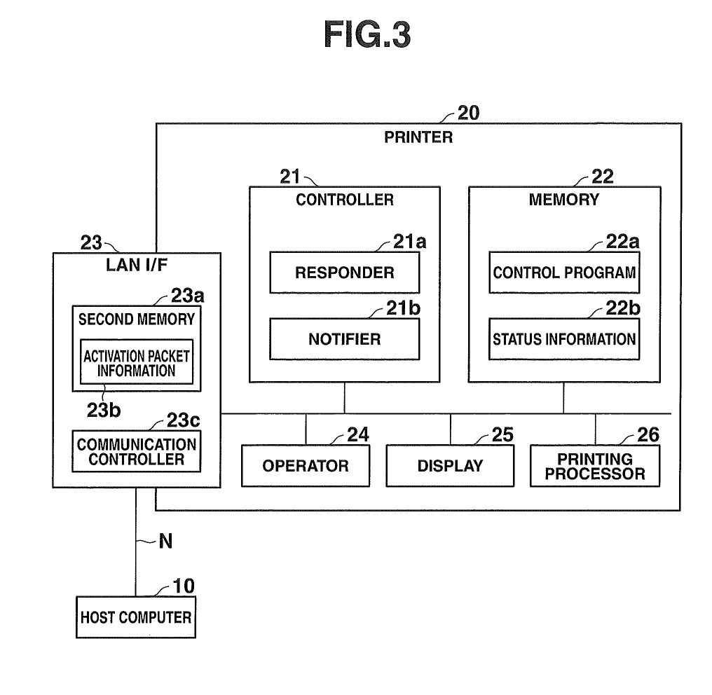

Next, with reference to FIG. 3, and explanation will be given of a structure of the printer 20 illustrated in FIG. 1. The printer 20 includes a controller 21, a memory 22, the LAN I/F 23, an operator 24, a display 25, and a printing processor 26.

The LAN I/F 23 includes a communication interface device like an NIC. The LAN I/F 23 performs various communications with the host computer 10 connected through the network N under the control of the controller 21. In addition, the LAN I/F 23 includes a second memory 23a and a communication controller 23c, and has a WOL function of activating the printer 20 upon reception of a predetermined activation packet when the printer 20 is in the power saving mode.

The operator 24 includes input interface devices like multiple operation buttons. The operator 24 accepts various operations given by the user, and supplies signals corresponding to the accepted various operations to the controller 21.

The display 25 includes a display device like an LCD. The display 25 displays various images based on various image data supplied from the controller 21. For example, the display 25 displays the mode of the whole printer 20, the remaining quantity of paper, the remaining quantity of toner, and the like.

The operator 24 and the display 25 may be commonly realized by a so-called touch panel. In this case, an input interface device and a display device included in the touch panel are superimposed with each other, and an operation signal corresponding to a position operated by the user in the touch panel is supplied to the controller 21.

The printing processor 26 includes a printer engine, a paper feeder tray, a feeder device that feeds recording paper (paper) fed from the paper feeder tray, multiple image formation units (for example, image formation units corresponding to cyan, magenta, yellow, and black), and the like. The image formation units include a photoreceptor drum, a charging device, a printer head (LED (Light Emitting Diode) head), a developer, and a transfer device. The printing processor 26 performs a printing process based on a print job received from the controller 21. The printing processor 26 converts print data included in the print job into image data in a format processed by the printer engine on the fed paper under the control of the controller 21. The printing processor 26 prints and outputs the converted image data in accordance with a predetermined setting condition.

The memory 22 includes memory devices like an HDD, a ROM, and a flash memory. The memory 22 stores various programs and data utilized by the controller 21 to perform various processes, and various data generated or obtained through the various processes executed by the controller 21. The memory 22 stores the unicast address information allocated to the printer 20. For example, the printer 20a illustrated in FIG. 1 stores, in the memory 22, the unicast address information including the IP address “192.168.1.2” and the MAC address “p1”.

In addition, the memory 22 stores the multicast address information to receive a search packet transmitted in a multicast manner. The printer 20a and the printer 20b subjected to a monitoring and illustrated in FIG. 1 store, in the respective memories 22, respective multicast address information each including a preset IP address and a preset MAC address.

Still further, the memory 22 stores a control program 22a and status information 22b.

The status information 22b represents, as illustrated in FIG. 5, various status including, for example, the operation mode (normal mode, power saving mode, and the like) of the printer 20, the remaining quantity of paper, and the remaining quantity of toner. The status information 22b is updated under the control of the controller 21 when various statuses are obtained at a predetermined timing.

The controller 21 includes a CPU serving as a main control processor, a RAM serving as a main memory thereof, and the like. The controller 21 is connected with respective elements of the printer 20 through a system bus that is a transmission channel to transfer an instruction and data, and controls the whole printer 20. The controller 21 may partially include an exclusive circuit like an ASIC.

The controller 21 executes the control program 22a, thereby serving as a responder 21a and a notifier 21b. The respective elements 21a, 21b perform processes to be discussed later.

Conversely, the second memory 23a of the LAN I/F 23 stores activation packet information 23b.

The activation packet information 23b is information to determine whether or not the activation packet as an activation instruction is received when the printer 20 is operating in the power saving mode. As illustrated in FIG. 6, for example, the activation packet information 23b includes multiple bit patterns. The controller 21 determines whether or not the activation packet is received based on the multiple bit pattern of the activation packet information 23b, and the bit pattern of a signal received through the network N.

More specifically, when an address (MAC address) request packet generated through an ARP (Address Resolution Protocol) and an NS (Neighbor Solicitation), a magic packet (registered trademark) generated through a broadcast frame, and the like are utilized as the activation packet to the printer 20, the bit pattern corresponding to each packet is included in the activation packet information 23b.

In addition, the activation packet information 23b does not include a bit pattern corresponding to the search packet to be discussed later. That is, the search packet is not the activation packet, and when the printer 20 is operating in the power saving mode, the printer 20 is not activated by the search packet, but maintains the power saving mode.

Still further, the communication controller 23c of the LAN I/F 23 includes a controller of a communication interface device like an NIC. The communication controller 23c can control the LAN I/F 23 as long as power is supplied to the communication controller 23c even if power supply to the CPU and the like of the controller 21 is terminated in the power saving mode. That is, the communication controller 23c is activated even when the printer 20 is in the power saving mode, thus capable of executing the process of the WOL function.

In the power saving mode, the printer 20 holds the information stored in the memory like the RAM, or transfers the contents stored in the memory to the HDD in a recoverable manner, and terminates a power supply to the controller 21. At this time, a power feeding to the communication controller 23c is maintained but the communication controller 23c in the power saving mode does not accept packets other than the predetermined activation packet defined in accordance with the activation packet information 23b to be discussed later.

In the monitoring system 1 employing the above-explained structure, the host computer 10 executes a process (monitoring process) of periodically obtaining the status of the printer 20 set as the monitoring-target apparatus. Conversely, the printer 20 executes a process (packet receiving process) of receiving various packets through the network N.

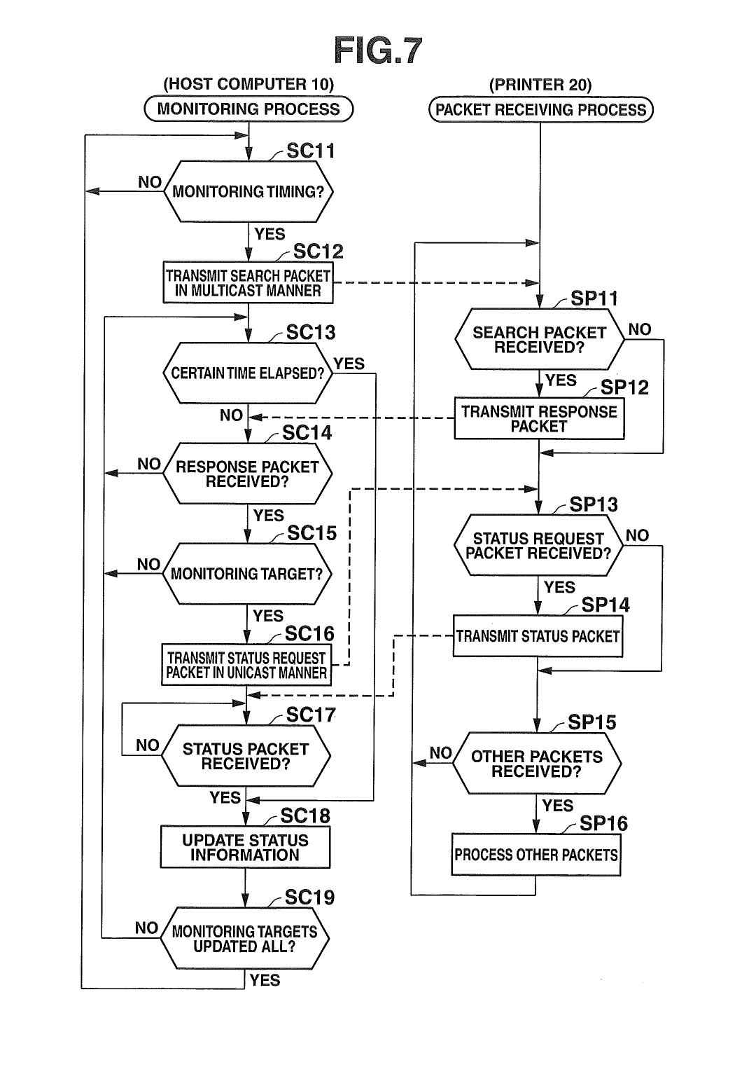

With reference to FIG. 7, an explanation will be given of the monitoring process executed by the host computer 10 and the packet receiving process executed by the printer 20.

The inquirer 11a of the host computer 10 determines whether or not it becomes a monitoring timing set to monitor the printer 20 set as the monitoring-target apparatus, and keeps a standby mode until it is determined that the monitoring timing has come (step SC11: NO). It is typical that the monitoring timing is set as a predetermined periodical time cycle like a one-minute cycle and a five-minute cycle.

When determining (step SC11: YES) that it becomes the monitoring timing, the inquirer 11a inquires whether or not a status of the printer 20 set as the monitoring-target apparatus is obtainable prior to a transmission of a status request packet for monitoring to the printer 20. That is, the inquirer 11a determines whether or not the printer 20 is in the power saving mode so as not to unnecessarily disturb the power saving mode through the monitoring to the printer 20 in the power saving mode.

The inquirer 11a performing this inquiry reads the printer address information 12b stored in the memory 12, specifies the multicast address information in the printer address information 12b as a transmission destination to generate a search packet. For example, this inquirer 11a generates this search packet through an SSDP (Simple Service Discovery Protocol).

The inquirer 11a transmits (step SC12) the generated search packet to the network N in the multicast manner through the communicator 13. Accordingly, the search packet is transmitted to the printer 20 (printer 20a and printer 20b) subjected to the monitoring. Since the search packet is transmitted in a multicast manner to multiple devices including the printer 20, no address resolution request of the transmission destination by the ARP, NS, and the like is issued. Hence, even if the transmission destination printer 20 is in the power saving mode, transmission of the search packet does not cancel the power saving mode.

Subsequently, the timer 11f of the host computer 10 counts an elapsed time after the inquirer 11a made an inquiry, and determines whether or not a certain time has elapsed (step SC13). During this operation, the receiver 11b waits for a reception of a reply packet to the transmitted search packet. Hence, the receiver 11b receives (step SC13: NO) the reply packet until the preset upper limit time has elapsed.

Conversely, when the printer 20 is in a normal mode, the controller 21 of the printer 20 determines in step SP11 whether or not the search packet is received from the host computer 10 (step SP11). The controller 21 checks, in addition to the port and the protocol where the LAN I/F 23 received the search packet transmitted from the host computer 10, the data format, and the like, whether or not the transmission destination of the search packet is consistent with one of the multicast address information to which the local device should respond.

The controller 21 performing such a checking determines (step SP11: YES) that the search packet is received when it is determined that the search packet is transmitted to the local printer 20. Conversely, in other cases, the controller 21 determines (step SP11: NO) that no search packet is received, and the process progresses to step SP13.

When the controller 21 determines (step SP11: YES) that the search packet is received, the received search packet is given to each daemon in accordance with the protocol and the data, and is processed. Next, the responder 21a generates a response packet while specifying, as a transmission destination, the unicast address information of the host computer 10 represented by the transmission originator of the search packet. For example, the responder 21a generates the response packet in accordance with a scheme defined based on an SSDP. The responder 21a transmits (step SP12) the generated response packet to the network N through the LAN I/F 23. Subsequently, the controller 21 of the printer 20 waits for a request for an obtainment of the status from the host computer 10.

Conversely, the receiver 11b of the host computer 10 determines (step SC14) whether or not the response packet to the search packet is received until a certain time elapses after the inquirer 11a transmits the search packet in a multicast manner. The receiver 11b checks the port and the protocol where the response packet transmitted from the printer 20 is received, the data format, and the like to determine whether or not it is a response to the searching.

When the receiver 11b determines (step SC14: NO) that no response packet is received, the process returns to the step SC13. Conversely, when the receiver 11b determines (step SC14: YES) that the response packet is received, the determiner 11e determines (step SC15) whether or not the device having transmitted the response packet is a monitoring-target apparatus based on the unicast address information represented by the transmission originator of the response packet.

The determiner 11e performs this determination process through specifying the printer 20 that has transmitted the response packet. When, for example, the printer 20a illustrated in FIG. 1 transmitted the response packet, the transmission originator of the response packet represents the unicast address information (IP address “192.168.1.2” and MAC address “p1”). The determiner 11e compares this unicast address information with the unicast address information contained in the printer address information 12b stored in the memory 12, and extracts the unicast address information matching the unicast address information of the transmission originator from the printer address information 12b, thereby specifying the printer 20 that has transmitted the response packet.

When the printer 20 that has transmitted the response packet can be specified, the determiner 11e determines (step SC15: YES) that this printer 20 is the monitoring-target apparatus, and the process progresses to step SC16. For example, the unicast address information (IP address “192.168.1.2” and MAC address “p1”) represented by the transmission originator of the response packet can be extracted from the printer address information 12b, and thus it is determined that the printer 20a which has transmitted this response packet is the monitoring target. The printer 20 determined as the monitoring target is operated in the normal mode at least when transmitted the response packet. Hence, the status thereof is obtainable.

When the unicast address information having only MAC address matching among the unicast address information represented by the transmission originator of the response packet can be extracted from the printer address information 12b, the determiner 11e determines that such a printer 20 is the monitoring target. That is, in this case, it is determined that the IP address allocated to this printer 20 has changed, and the IP address in the extracted unicast address information is changed to the IP address of the unicast address information represented by the transmission originator of the response packet, thereby updating the printer address information 12b. At this time, the determiner 11e reflects the changed IP address also in the printer status information 12c, thereby updating the printer status information 12c.

Conversely, when no unicast address information matching the unicast address information represented by the transmission originator of the response packet is not extractable from the printer address information 12b, the determiner 11e determines (step SC15: NO) that the device which has transmitted the response packet is not a monitoring target, and the process returns to the step SC13.

When the determiner 11e determines (step SC15: YES) that the device which has transmitted the response packet is the monitoring target, that is, a target for a status obtainment, the requester 11c requests the printer 20 which is the transmission originator of the response packet to obtain the status. In order to perform this request, the requestor 11c generates a status request packet while specifying the unicast address information represented by the transmission originator of the response packet as the transmission destination. For example, the requester 11c generates this status request packet through an SNMP (Simple Network Management Protocol).

The requester 11c transmits (step SC16) the generated status request packet to the network N through the communicator 13 in a unicast manner. Accordingly, the status request packet is transmitted to the printer 20 that has transmitted the response packet. Next, the receiver 11b of the host computer 10 determines (step SC17) whether or not a status packet is received, and becomes (step SC17: NO) a standby condition until the status packet is received.

Conversely, the controller 21 of the printer 20 determines (step SP13) whether or not the status request packet is received from the host computer 10. The controller 21 checks the port and the protocol where the LAN I/F 23 received the status request packet transmitted from the host computer 10, the data format, and the like, thereby determining whether or not the received packet is the status request packet.

The controller 21 performing such a checking determines (step SP13: YES) that the status request packet has been received when it is determined that the received packet is the status request packet to the local printer. Conversely, in other cases, the controller 21 determines (step SP13: NO) that no status request packet has been received, and the process progresses to step SP15.

When the controller 21 determines (step SP13: YES) that the status request packet has been received, the received status request packet is given to each daemon in accordance with the protocol and data, and the notifier 21b generates the status packet. For example, the notifier 21b involves all status information 22b read from the memory 22 or predetermined status information extracted from the status information 22b in a data piece, and specifies the unicast address information of the host computer 10 as the transmission destination to generate the status packet. The unicast address information of the host computer 10 is represented by, for example, the transmission originator of the status request packet. In addition, this status packet is generated through an SNMP. The notifier 21b transmits (step SP14) the generated status packet to the network N through the LAN I/F 23. Hence, the notifier 21b notifies the host computer 10 of the status of the printer 20.

Conversely, when determining (step SC17: YES) that the receiver 11b of the host computer 10 received the status packet after the status request packet had been transmitted, the receiver 11b changes the status information included in the printer status information 12c stored in the memory 12 to the status information included in the data piece of the status packet, thereby updating (step SC18) the printer status information 12c. The printer having the status information to be updated is specified based on, for example, the unicast address information represented by the transmission originator of the status packet.

Next, the information presenter 11d analyzes the updated printer status information 12c, and displays an analysis result through a predetermined application on the screen of the display 15. Hence, the information presenter 11d presents the status of the printer 20 notified therefrom to the user.

Subsequently, the controller 11 determines (step SC19) whether or not the printer status information 12c is updated for all monitoring targets, and when determining (step SC19: YES) that such information is updated, the process returns to the step SC11. Through the above operations, the successive monitoring process executed by the host computer 10 completes, and the inquirer 11a becomes a standby condition until a next monitoring timing comes.

Conversely, when the controller 11 determines (step SC19: NO) that the printer status information 12c is not updated for all monitoring targets, the process returns to the step SC13. Next, when the timer 11f determines in the step SC13 that the certain time has elapsed (step SC13: YES), the information presenter 11d determines in the printer status information 12c that the status corresponding to the printer 20 unspecifiable for the determiner 11e for the certain time is “no response” “power saving mode”. Hence, the printer status information 12c for all monitoring targets is updated (step SC18, step SC19: YES).

On the other hand, when the controller 21 of the printer 20 determines (step SP11: NO) that no search packet is received, or determines (step SP13: NO) that no status request packet is received, the controller 21 determines (step SP15) whether or not the other packet than the search packet and the status request packet is received.

Example other packet is a printing request packet generated by an LPR (Line PRinter daemon protocol), an address (MAC address) request packet generated by an ARP or an NS, or a magic packet (registered trademark) generated as a broadcast frame. The controller 21 determines (step SP15: YES) that the other packet is received when determining that such packet is transmitted to the local printer 20 based on the transmission destination of such a packet.

When the controller 21 determines (step SP15: NO) that no other packet is received, the process returns to the step SP11. That is, when the printer 20 is in the normal mode, it becomes a standby mode until any packet is received.

Conversely, the controller 21 performs (step SP16) various processes based on the protocol of the received other packet and the data thereof, and the process returns to the step SP11. Through the above-explained operations, the successive packet receiving process when the printer 20 is in the normal mode completes. When the printer 20 is in the normal mode, even if the magic packet (registered trademark) is received, the printer 20 has no particular process to be executed, and thus the magic packet (registered trademark) is discarded.

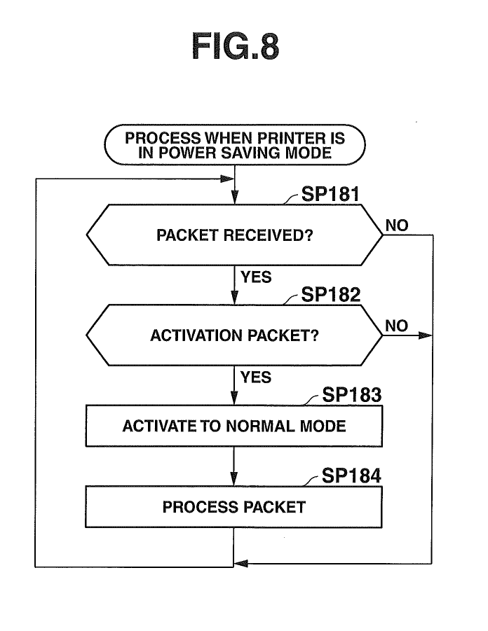

Next, with reference to FIG. 8, an explanation will be given of a process when the printer 20 is in the power saving mode.

When the printer 20 is in the power saving mode, the communication controller 23c of the printer 20 determines whether or not the LAN I/F 23 received a packet through the network N. The communication controller 23c checks, in addition to the port and the protocol where the packet is received, the data format, and the like, the transmission destination of the packet. The communication controller 23c performing such a checking determines (step SP181: YES) that the packet is received when determining that the packet is transmitted to the local printer 20, and the process progresses to step SP182. Conversely, in other cases, the communication controller 23c determines (step SP181: NO) that no packet is received, and terminates the process. Subsequently, the communication controller 23c stands by until a packet is received in the step SP181.

The communication controller 23c determines in the step SP182 that whether or not the received packet is the activation packet (step SP182). When receiving the packet, the communication controller 23c reads the activation packet information 23b from the second memory 23a. Next, the communication controller 23c determines (step SP182: YES) that the received packet is the activation packet when the bit pattern of the received signal through the LAN I/F 23 matches any one of the bit patterns in the activation packet information 23b stored in the second memory 23a.

In this case, the communication controller 23c changes the printer 20 in the power saving mode to be the normal mode by supplying power to the controller 21, thereby activating (step SP183) the printer 20. That is, when receiving the predetermined activation packet as an activation instruction, the communication controller 23c changes the printer 20 in the power saving mode to be the state which permits an obtainment of the status of the local apparatus (printer 20), thereby activating the printer 20. Next, the controller 21 starting an operation performs (step SP184) various processes based on the protocol of the received packet and the data thereof. Subsequently, the communication controller 23c terminates the process.

Conversely, when the communication controller 23c determines (step SP182: NO) that the received packet is not the activation packet, the communication controller 23c does not activate the printer 20 in the power saving mode, and keeps the printer 20 in the power saving mode. That is, when the received packet is not the activation packet, the activating process on the printer 20 and the packet process by the controller 21 are not executed, but the process is terminated. For example, even if the search packet based on an inquiry from the inquirer 11a of the host computer 10 is received when the printer 20 is in the power saving mode, the communication controller 23c keeps the printer 20 in the power saving mode. That is, when the printer 20 is in the power saving mode, the communication controller 23c maintains the power saving mode as long as the activation packet is received. Through the above-explained operations, the successive process when the printer 20 is in the power saving mode completes.

According to the above-explained monitoring system 1, when the host computer 10 that is the monitoring apparatus attempts to obtain the status of the printer 20 that is the monitoring-target apparatus, the host computer 10 inquires whether or not the printer 20 is in the power saving mode, and checks whether or not the status is obtainable prior to requesting the obtainment of the status. Hence, it becomes possible for the monitoring apparatus to monitor the status of the printer 20 while suppressing an interruption of the power saving mode of the printer 20.

The embodiment of the present invention was explained above, but such embodiment is merely an example, and the applicable range of the present invention is not limited to such an embodiment. That is, the embodiment of the present invention permits various modifications, and all embodiments that can carry out the present invention are within the scope and spirit of the present invention.

For example, in the above-explained embodiment, the monitoring-target apparatus is the printer device that is the printers 20a to 20c. However, the monitoring-target apparatus of the monitoring system of the present invention is not limited to the printer device, and may be other communication apparatuses like a general PC, a server, a copying machine, and a facsimile

In addition, in the above-explained embodiment, the host computer 10 that is the monitoring apparatus and the printers 20a to 20b that are the printer devices subjected to a monitoring are connected in the same network segment. However, since a multicast transmission and a unicast transmission, not a broadcast transmission are applied, the respective apparatuses may be connected in different network segments through a router.

Still further, in the above-explained embodiment, the printers 20 are monitored by the one host computer 10. According to the present invention, however, multiple host computers 10 may monitor a common printer 20.

Yet further, in the above-explained embodiment, SSDP is applied as the search packet to inquire whether or not the printer 20 is in the power saving mode. According to the present invention, however, as long as the printer 20 in the power saving mode can recognize an inquiry and respond thereto without causing the printer 20 in the power saving mode to recover to the normal mode, other medium than SSDP can be applied as the response request.

The programs that realize the respective functional elements of the host computer 10 and the printer 20 explained in the above-explained embodiment may be provided in a manner allowing a CPU and the like controlling, for example, conventional personal computer and information terminal device to execute such programs. How to provide such programs is optional. For example, the program stored in a computer-readable recording medium like a flexible disk, a CD (Compact Disc) ROM, a DVD (Digital Versatile Disc) ROM, or a memory card may be provided. In addition, the program superimposed on carrier waves may be provided through a communication medium like the Internet. For example, the program may be uploaded on a bulletin board (BBS: Bulletin Board System) over the communication network, and may be distributed therethrough. In addition, the above-explained processes may be executed when the program is executed and also executed like other application programs under the control of an OS.

Having described and illustrated the principles of this application by reference to one preferred embodiment, it should be apparent that the preferred embodiment may be modified in arrangement and detail without departing from the principles disclosed herein and that it is intended that the application be construed as including all such modifications and variations insofar as they come within the spirit and scope of the subject matter disclosed herein.

What is claimed is:

1. A monitoring system comprising:
a monitoring apparatus; and
a monitoring-target apparatus connected with the monitoring apparatus via a network,
wherein:
the monitoring apparatus comprises an inquirer that inquires whether or not the monitoring-target apparatus is capable of obtaining a status thereof;
the monitoring-target apparatus comprises a responder that transmits, when the monitoring-target apparatus is in a first status in which the status is obtainable, a response to the inquiry when the monitoring-target apparatus receives the inquiry;
the monitoring apparatus further comprises:
a receiver that receives the response to the inquiry transmitted from the monitoring-target apparatus; and
a requester that requests the monitoring-target apparatus having transmitted the received response to obtain a statement of the monitoring-target apparatus when the receiver receives the response; and
the monitoring-target apparatus further comprises a communication controller that does not respond to the inquiry when the monitoring-target apparatus receives the inquiry and the monitoring-target apparatus is in a second status in which the status is not obtainable, and that maintains the monitoring-target apparatus in the second status.

2. The monitoring system according to claim 1, wherein when receiving a predetermined activation instruction when the monitoring-target apparatus is in the second status in which the status is not obtainable, the communication controller changes the monitoring-target apparatus from the second status to the first status.

3. The monitoring system according to claim 1, wherein:
the monitoring-target apparatus further comprises a notifier that notifies the monitoring apparatus of the status of the monitoring-target apparatus when the monitoring apparatus requests an obtainment of the status of the monitoring-target apparatus; and
the monitoring apparatus further comprises an information presenter that presents the status notified from the monitoring-target apparatus.

4. The monitoring system according to claim 1, wherein:
the inquirer performs the inquiring through a multicast transmission of a predetermined response request over the network to multiple apparatuses including the monitoring-target apparatus;
the responder transmits a response to the response request to the monitoring apparatus when the monitoring-target apparatus is in the first status and when receiving the response request transmitted from the monitoring apparatus; and
the requester requests the monitoring-target apparatus to obtain the status through a unicast transmission of a request for an obtainment of the status of the monitoring-target apparatus to the monitoring-target apparatus that is a transmission originator of the response received by the receiver.

5. The monitoring system according to claim 1, wherein:
the monitoring apparatus further comprises:
a memory that stores address information on the monitoring-target apparatus subjected to an obtainment of the status; and
a determiner that compares the address information on the monitoring-target apparatus which is a transmission originator of the response received by the receiver with the address information on the target of the obtainment of the status stored in the memory to determine whether or not the transmission originator of the received response is a target of the obtainment of the status; and
the requester requests the monitoring-target apparatus that is the transmission originator of the received response to obtain the status when the determiner determines that the monitoring-target apparatus which is the transmission originator of the received response is the monitoring-target apparatus subjected to the obtainment of the status.

6. A monitoring apparatus that is an external apparatus monitoring a monitoring-target apparatus comprising a responder and a communication controller,
wherein:
the responder transmits, when the monitoring-target apparatus is in a first status in which a status thereof is obtainable and the monitoring-target apparatus receives a predetermined inquiry, a response to the inquiry to the external apparatus;
the communication controller does not respond to the inquiry when the monitoring-target apparatus receives the inquiry and the monitoring-target apparatus is in a second status in which the status is not obtainable, and that maintains the local monitoring-target apparatus in the second status;
the monitoring apparatus comprises:
an inquirer that performs the inquiry as to whether or not the monitoring-target apparatus is obtainable the status thereof;
a receiver that receives the response to the inquiry transmitted from the monitoring-target apparatus when the monitoring-target apparatus is in the first status; and
a requester that requests, when the receiver receives the response, the monitoring-target apparatus having transmitted the received request to obtain the status of the monitoring-target apparatus.

7. A monitoring-target apparatus connected with a monitoring apparatus via a network, the monitoring apparatus comprising:
an inquirer that performs an inquiry as to whether or not the monitoring-target apparatus is obtainable a status thereof;
a receiver that receives a response to the inquiry transmitted from the monitoring-target apparatus when the monitoring-target apparatus is in a first status in which the status is obtainable; and
a requester that requests, when the receiver receives the response, the monitoring-target apparatus having transmitted the received request to obtain the status of the monitoring-target apparatus,
the monitoring-target apparatus comprising:
a responder that transmits, when the monitoring-target apparatus receives the inquiry and the monitoring-target apparatus is in the first status, the response to the inquiry; and
a communication controller that does not respond to the inquiry when the monitoring-target apparatus receives the inquiry from the monitoring apparatus and the monitoring-target apparatus is in a second status in which the status is not obtainable, and that maintains the local monitoring-target apparatus in the second status.

8. A monitoring method for monitoring a monitoring-target apparatus comprising a responder and a communication controller,
wherein:
the responder transmits, when the monitoring-target apparatus is in a first status in which a status thereof is obtainable and the monitoring-target apparatus receives a predetermined inquiry, a response to the inquiry to a monitoring apparatus connected with the monitoring-target apparatus via a network; and
the communication controller does not respond to the inquiry when the monitoring-target apparatus receives the inquiry and the monitoring-target apparatus is in a second status in which the status is not obtainable, and that maintains the local monitoring-target apparatus in the second status;
the monitoring method comprises:
an inquiring step for performing the inquiry as to whether or not the status of the monitoring-target apparatus is obtainable;
a receiving step for receiving the response to the inquiry transmitted from the monitoring-target apparatus when the monitoring-target apparatus is in the first status; and
a requesting step for requesting, when the response is received through the receiving step, the monitoring-target apparatus having transmitted the received request to obtain the status of the monitoring-target apparatus.

9. A computer-readable non-transitory recording medium having stored therein a monitoring program that causes a computer to execute a monitoring method for monitoring a monitoring-target apparatus comprising a responder and a communication controller,
wherein:
the responder transmits, when the monitoring-target apparatus is in a first status in which a status thereof is obtainable and the monitoring-target apparatus receives a predetermined inquiry, a response to the inquiry to a monitoring apparatus connected with the monitoring-target apparatus via a network; and
the communication controller does not respond to the inquiry when the monitoring-target apparatus receives the inquiry and the monitoring-target apparatus is in a second status in which the status is not obtainable, and that maintains the local monitoring-target apparatus in the second status;
the monitoring program causes the computer to execute:
performing the inquiry as to whether or not the status of the monitoring-target apparatus is obtainable;
receiving the response to the inquiry transmitted from the monitoring-target apparatus when the monitoring-target apparatus is in the first status; and
requesting, when the response is received, the monitoring-target apparatus having transmitted the received request to obtain the status of the monitoring-target apparatus.
